(19) United States
(12) Patent Application Publication
(10) Pub. No.: US 2019/0122290 A1
(43) Pub. Date: Apr. 25, 2019

(54) CONTAINER, SETTLEMENT APPARATUS, AND SHOP SYSTEM

(71) Applicant: FUJITSU LIMITED, Kawasaki-shi (JP)

(72) Inventors: Satoshi Yoshimura, Kouto (JP); Makoto Goda, Warabi (JP); Masato Takeishi, Yokohama (JP)

(73) Assignee: FUJITSU LIMITED, Kawasaki-shi (JP)

(21) Appl. No.: 16/163,715

(22) Filed: Oct. 18, 2018

(30) Foreign Application Priority Data
Oct. 20, 2017 (JP) 2017-203962

(51) Int. Cl. G06Q 30/06; G06Q 30/02; G06Q 20/20

(52) U.S. Cl. CPC G06Q 30/0635; G06Q 20/202; G06Q 30/0268

(57) ABSTRACT

A container includes: a touch screen configured to display a first area and a second area, the first area including an image regarding a commodity advertisement, the second area including an operation unit configured to receive a manipulation by a user; and a transmission circuitry configured to transmit a purchase request when the operation unit displayed on the touch screen receives the manipulation, the purchase request including a first identification for the container and a second identification for a commodity displayed on the first area of the touch screen.

### CROSS-REFERENCE TO RELATED APPLICATION

This application is based upon and claims the benefit of priority of the prior Japanese Patent Application No. 2017-203962, filed on Oct. 20, 2017, the entire contents of which are incorporated herein by reference.

### FIELD

The embodiment discussed herein is related to a container, a settlement device, and a shop system.

### BACKGROUND

In the related art, sales of a commodity to a shop-visiting customer are carried out by settlement with a POS terminal installed at a register counter. For example, in a pub or the like, settlement is performed with the POS terminal for all the ordered commodities put together. In the case of prepayment (prepaid), settlement is performed with the POS terminal at the time of receipt of the commodity at the register counter.

In the case of prepayment, after settlement is completed once, a customer holding the commodity may stay in the shop. For example, in a coffee shop or the like, a customer takes a cup containing a beverage such as coffee purchased in prepayment to a table in the shop, and then drinks the beverage after sitting at the table. As such, it is important to urge the customer who stays in the shop to purchase additional commodities. As a method of urging the purchase of additional commodities, there are known commodity introduction by a shop employee, an advertisement presented on a paper medium placed on a table or shelf and presented on walls of the shop, and a beverage container displaying advertisement information on a display unit.

Examples of the related art include International Publication Pamphlet No. WO 2010-21061 and Japanese Laid-open Patent Publication No. 2014-13431.

### SUMMARY

According to an aspect of the embodiments, a container for internet of things (IoT) includes: a touch screen configured to display a first area and a second area, the first area including an image regarding a commodity advertisement, the second area including an operation unit configured to receive a manipulation by a user; and a transmission circuitry configured to transmit a purchase request when the operation unit displayed on the touch screen receives the manipulation, the purchase request including a first identification for the container and a second identification for a commodity displayed on the first area of the touch screen.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 illustrates an explanatory diagram of a configuration example of a shop system according to an embodiment;

FIG. 2 illustrates a functional block diagram of a configuration of an IoT container according to the embodiment;

FIG. 3 illustrates a functional block diagram of a configuration of an IoT container management server according to the embodiment;

FIG. 4 illustrates an example of a data structure of a container management table according to the embodiment;

FIG. 5 illustrates an example of a data structure of a shop-visiting customer management table according to the embodiment;

FIG. 6 illustrates an example of a data structure of a distribution rule table according to the embodiment;

FIG. 7 illustrates a functional block diagram of a configuration of a first terminal according to the embodiment;

FIG. 8 illustrates a functional block diagram of a configuration of a POS terminal according to the embodiment;

FIG. 9A illustrates an example of an image displayed on a display unit of the IoT container;

FIG. 9B illustrates another example of the image displayed on the display unit of the IoT container;

FIG. 9C illustrates another example of the image displayed on the display unit of the IoT container;

FIG. 9D illustrates another example of the image displayed on the display unit of the IoT container;

FIG. 9E illustrates another example of the image displayed on the display unit of the IoT container;

FIG. 9F illustrates another example of the image displayed on the display unit of the IoT container;

FIG. 10 illustrates an example of an editing screen of the first terminal;

FIG. 11 illustrates an explanatory diagram for explaining a flow of processing a shop system according to the embodiment;

FIG. 12 illustrates an explanatory diagram for explaining another flow of processing of the shop system according to the embodiment;

FIG. 13 illustrates an explanatory diagram for explaining another flow of processing of the shop system according to the embodiment;

FIG. 14 illustrates an explanatory diagram for explaining an example of use of the shop system according to the embodiment;

FIG. 15 illustrates an explanatory diagram for explaining an example of the use of the shop system according to the embodiment; and

FIG. 16 illustrates an example of a computer that executes a program.

### DESCRIPTION OF EMBODIMENTS

In a case where a customer intends to purchase an additional commodity after prepayment, the customer will visit the register counter again and perform settlement for purchasing additional commodities, which is troublesome for the customer.

According to one aspect of the present disclosure, there is provided a technology such as a container, a settlement device, a shop system, a purchase notification method, a settlement method, and the like that may reduce a trouble of a customer at the time of purchasing a commodity.

Hereinafter, a container, a settlement device, a shop system, a purchase notification program, a settlement program, a purchase notification method, and a settlement method according to the embodiment will be described with reference to the drawings. In the embodiment, the same reference numerals are given to configurations having the same function, and redundant description thereof will be omitted. The container, the settlement device, the shop system, the purchase notification program, the settlement program, the purchase notification method, and the settlement method to be described in the following embodiment are merely examples and do not limit the embodiment. Further, each embodiment to be described in the following may be suitably combined within a range not inconsistent.

Configuration of Shop System

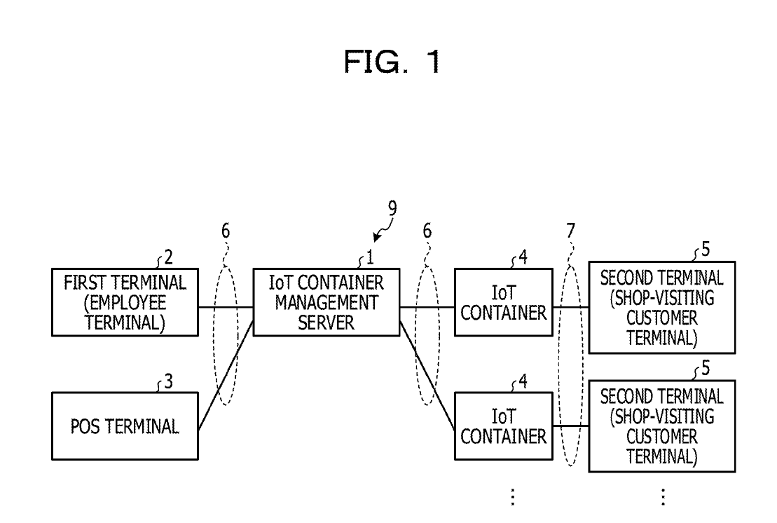

FIG. 1 illustrates a configuration example of a shop system according to an embodiment. As illustrated in FIG. 1, a shop system 9 of a shop includes an IoT container management server 1, a first terminal 2, a point of sales (POS) terminal 3, an internet of things (IoT) container 4, and a second terminal 5.

The IoT container management server 1 is a server device that manages the IoT container 4 used in the shop. For example, when the IoT container management server 1 receives registration of an image of a target to be displayed on a display unit of the IoT container 4 and acquires identification information of the IoT container 4 or the display unit of the IoT container 4, the IoT container management server 1 transmits the registered image to a transmission destination associated with the identification information. Then, the IoT container management server 1 displays an image on the display unit of the IoT container 4. That is, the IoT container management server 1 causes information such as a commodity advertisement corresponding to a user (customer) who utilizes the IoT container 4 to be automatically displayed on the display unit of the IoT container 4.

The IoT container 4 referred to here means a container having a communication function and a display function, and in the present embodiment, the IoT container 4 means a container containing a beverage (drink) such as coffee to be provided as a commodity at a shop where food service is provided. As described above, in the embodiment, the commodity provided by customer's order is drinks such as coffee provided by being poured into the IoT container 4. As for the commodity provided by the customer's order, it is not limited to drinks as long as it may fit in the IoT container 4, and food such as cake or the like may be used.

The IoT container management server 1 is communicably connected to the first terminal 2 and the POS terminal 3 via a network 6. The IoT container management server 1 is connected to the IoT container 4 so as to be able to communicate with each other via the network 6. The network 6 referred to here is, for example, WiFi, but is not limited thereto, and the network 6 may be another communication network such as a carrier network. The IoT container 4 is connected to the second terminal 5 so as to be able to communicate with each other via a network 7. The network 7 referred to here is Bluetooth such as Bluetooth (registered trademark) low energy (BLE) or the like, but is not limited thereto, and it suffices that the IoT container 4 and the second terminal 5 are communicably connected to each other. A configuration of the IoT container management server 1 will be described later.

The first terminal 2 is an example of a terminal for an employee of a shop. The first terminal 2 is, for example, a tablet terminal, but is not limited thereto, and the first terminal 2 may be a portable personal computer or the like. As an example, the first terminal 2 may be any other type of terminal as long as it may display the editing screen of the image to be displayed on the IoT container 4, or notify the IoT container management server 1 of information of the image to be displayed on the IoT container 4. The configuration of the first terminal 2 will be described later.

The POS terminal 3 identifies customer information of a customer who visits the shop and settles sales transaction of a commodity (for example, beverage) purchased by the customer. That is, the POS terminal 3 is an example of a settlement device.

For example, the POS terminal 3 reads a bar code of a shop specific prepaid card presented by the customer or a shop specific application screen displayed on the second terminal 5, which is a terminal for the shop-visiting customer to be described later, and identifies customer's customer information (shop-visiting customer ID (IDentifier)). Then, the POS terminal 3 settles purchase transaction of the beverage purchased by the customer with respect to the customer information. The POS terminal 3 transmits the customer information of the customer to the IoT container management server 1 so as to make the customer corresponding to the IoT container 4 which is the container of the beverage purchased by the customer, and receives identification information (IoT container ID) for identifying the IoT container 4 corresponding to the customer. Next, the POS terminal 3 stores settled settlement information in the storing unit. The settlement information includes, for example, identified customer information (customer's ID), a commodity name, a price, a purchase time, identification information of the IoT container 4 corresponding to the customer, and the like. The configuration of the POS terminal 3 will be described later.

The IoT container 4 is a container having a communication function, a display function, an operation function, and a bar code. For example, the IoT container 4 is a container that may display an image transmitted from the IoT container management server 1 on the display unit. The IoT container 4 is a container that receives an operation for transmitting a request for purchasing a commodity when an image of a commodity advertisement urging purchase of a predetermined commodity is displayed and transmits a purchase request to the IoT container management server 1 according to the received operation. The IoT container 4 is a container having a bar code so as to distinguish it from other IoT container 4. Such a bar code may be displayed on the display function or may be attached to the side of the container. Such a bar code corresponds to an IoT container ID to be described later.

The IoT container 4 is described as a beverage container including a mug or a tumbler, but is not limited thereto, and the IoT container 4 may be a food container. The IoT container 4 may be a container with a handle or a container without a handle. The IoT container 4 may be capable of separating a portion in which a beverage is actually contained and a portion having the communication function, the display function, and the operation function. For example, the IoT container 4 is a combination of a container and a container holder, and may be configured to allow the container holder to have a communication function, a display function, and an operation function. The configuration of the IoT container 4 will be described later.

The second terminal 5 is an example of a terminal for a customer. The second terminal 5 is, for example, a mobile phone such as a smartphone, but is not limited thereto, and the second terminal 5 may be a terminal such as personal digital assistants (PDAs), a portable personal computer, or the like. The second terminal 5 may be a terminal installed in a table or the like of a shop, or may be a terminal possessed by a customer. As an example, the second terminal 5 may be another type of terminal as long as it may display a shop specific application screen or may capture or refer to the image displayed on the display unit of the IoT container 4 from the shop specific application. The shop specific application installed in the second terminal 5 may be referred to as a “mobile application” in some cases.

Configuration of IoT Container 4

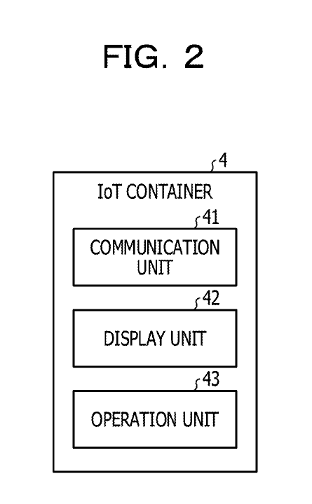

FIG. 2 illustrates a functional block diagram of the configuration of the IoT container 4 according to the embodiment. As illustrated in FIG. 2, the IoT container 4 includes a communication unit 41, a display unit 42, and an operation unit 43.

The communication unit 41 communicates with the IoT container management server 1 and the POS terminal 3 via the network 6 (see FIG. 1). The communication unit 41 communicates with the second terminal 5 via the network 7 (see FIG. 1). The communication unit 41 is realized by, for example, a network interface card (NIC) or the like. The communication unit 41 is an example of a transmission unit.

The display unit 42 is a display installed on the side of the IoT container 4, and displays an image transmitted from the IoT container management server 1. The display unit 42 is, for example, electronic paper, but is not limited thereto, and other types of display devices may be used as long as they may be attached to the IoT container 4 and display an image.

The operation unit 43 is an operation button installed on the side surface of the IoT container 4 and receives an input operation from a customer. The display unit 42 and the operation unit 43 may be an integrated touch screen on which a transparent touch sensor is disposed on the display unit 42.

In the IoT container 4, an image of a display target such as a commodity advertisement notified by communication from the IoT container management server 1 is displayed on the display unit 42. In this case, the IoT container 4 receives a customer's reaction to the image displayed on the display unit 42 by an input operation of the operation unit 43. Next, the IoT container 4 notifies the input result of the operation unit 43 together with identification information (IoT container ID) which is set in a memory or the like in the IoT container 4 to the IoT container management server 1.

For example, the IoT container 4 displays an image (for example, appearance of commodity or commodity name) of a commodity for which additional purchase is urged, which is notified by communication from the IoT container management server 1 on the display unit 42, and receives the presence or absence of purchase by operating the “YES”/“NO” button by the operation unit 43.

When there is a button operation requesting purchase (for example, depressing of “YES” button), the IoT container 4 notifies a purchase request for purchasing the commodity being displayed together with the IoT container ID from the communication unit 41 to the POS terminal 3 via the IoT container management server 1. The IoT container 4 may notify the IoT container ID and the purchase request directly to the POS terminal 3 without going through the IoT container management server 1.

Regarding the purchase request, the purchase request may include any content as long as it indicates the presence or absence of purchase of the commodity relating to the distributed image, for example, a commodity ID or the like. For example, when a commodity ID of an advertisement target is notified from the IoT container management server 1 together with a distribution image 133b based on the distribution rule table 133, the IoT container 4 notifies the commodity ID as a purchase request to the IoT container management server 1. In the IoT container management server 1, the purchase request including the commodity ID is notified to the POS terminal 3 as it is, together with the IoT container ID.

In a case where there is no notification of the commodity ID together with the distribution image 133b, the IoT container 4 simply notifies presence of purchase. In this case, the IoT container management server 1 specifies the commodity to which the purchase request was made by specifying the commodity ID corresponding to the distributed distribution image 133b based on the distribution rule table 133. Next, the IoT container management server 1 notifies the purchase request including the specified commodity ID together with the IoT container ID to the POS terminal 3.

In a case where there is a button operation (for example, pressing of the “NO” button) not requesting purchase, the IoT container 4 erases the image of the commodity on the display unit 42 because the customer indicated the intention to not purchase. In this case, the IoT container 4 may notify the IoT container ID and information without the distribution effect to the IoT container management server 1 from the communication unit 41.

Configuration of IoT Container Management Server 1

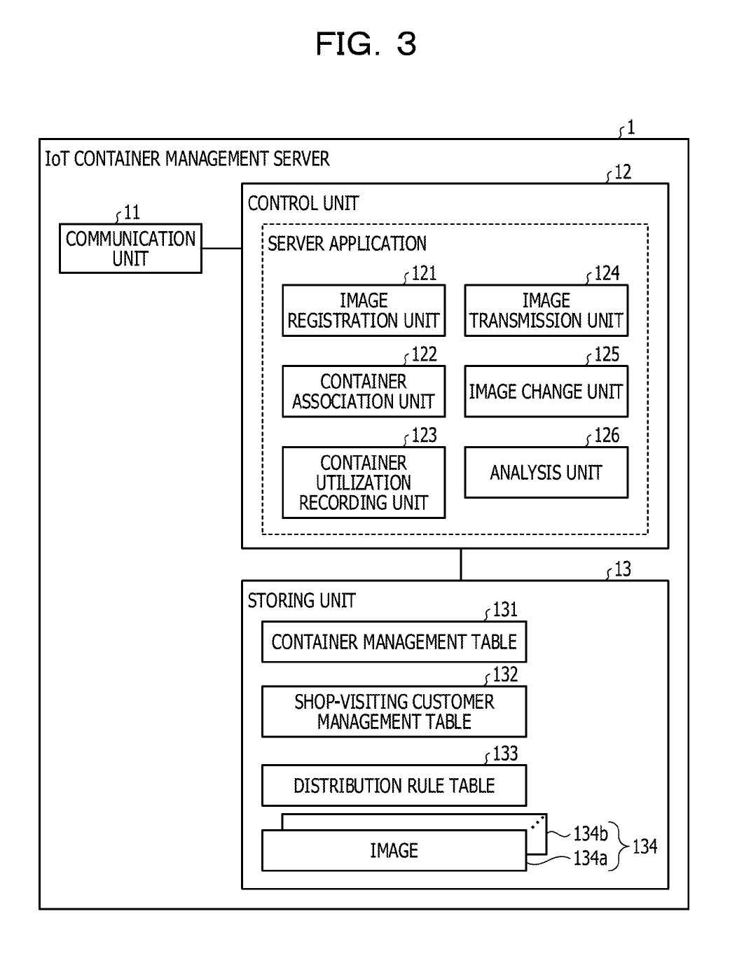

FIG. 3 illustrates a functional block diagram of the configuration of the IoT container management server 1 according to the embodiment. As illustrated in FIG. 3, the IoT container management server 1 includes a communication unit 11, a control unit 12, and a storing unit 13.

The communication unit 11 communicates with the first terminal 2, the POS terminal 3, and the IoT container 4 via the network 6 (see FIG. 1). The communication unit 11 is realized by, for example, an NIC or the like.

The control unit 12 corresponds to an electronic circuit such as a central processing unit (CPU). The control unit 12 includes an internal memory for storing programs defining various processing procedures and control data, and executes various processing by the programs and control data. Here, it is assumed that the control unit 12 executes processing by a server application. The control unit 12 includes an image registration unit 121, a container association unit 122, a container utilization recording unit 123, an image transmission unit 124, an image change unit 125, and an analysis unit 126.

The storing unit 13 is, for example, a semiconductor memory element such as a random access memory (RAM) and a flash memory, or a storage device such as a hard disk, an optical disk, or the like. The storing unit 13 has a container management table 131, a shop-visiting customer management table 132, a distribution rule table 133, and an image 134.

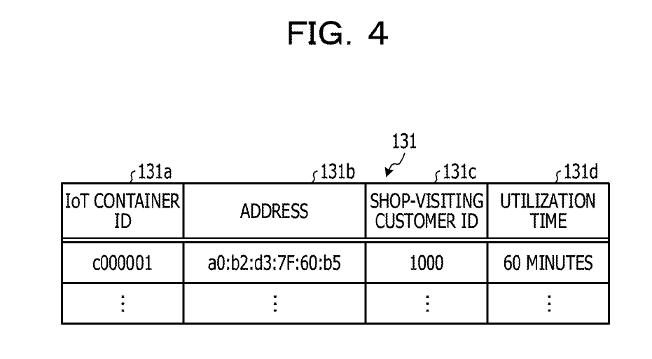

The container management table 131 manages information of each IoT container 4. Here, a data structure of the container management table 131 will be described with reference to FIG. 4.

FIG. 4 illustrates an example of a data structure of a container management table 131 according to the embodiment. As illustrated in FIG. 4, the container management table 131 stores an IoT container ID 131a, an address 131b, a shop-visiting customer ID 131c, and a utilization time 131d in association with each other. The IoT container ID 131a indicates identification information of the IoT container or the display unit 42 of the IoT container 4 or 4. The address 131b indicates the address of the IoT container 4. The address 131b is, for example, a media access control (MAC) address, but is not limited thereto, and may be an address indicating a destination of the IoT container 4. The shop-visiting customer ID 131c indicates customer information of the customer. The customer information referred to here is, for example, information indicating a bar code of a shop specific prepaid card or a shop specific application screen. The utilization time 131d indicates the time that the customer utilizes the IoT container 4.

As an example, in a case where the IoT container ID 131a is “c000001”, “a0:b2:d3:7F:60:b5” is stored as the address 131b and “1000” is stored as the shop-visiting customer ID 131c.

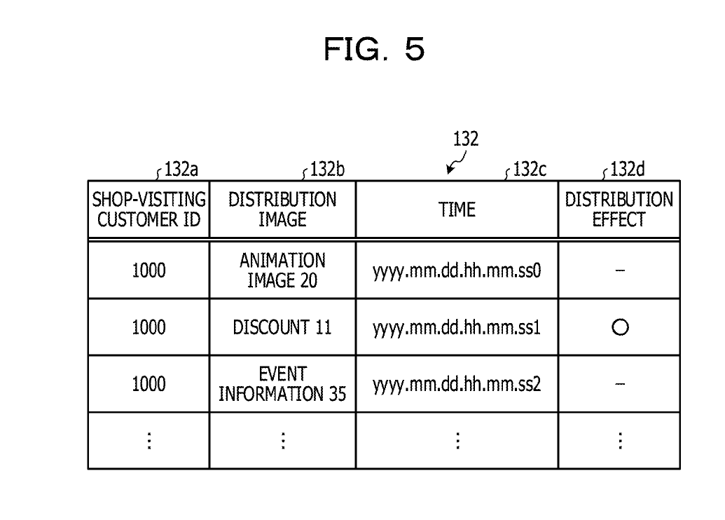

When returning to FIG. 3, a shop-visiting customer management table 132 manages information of the image distributed to the shop-visiting customer. Here, the data structure of the shop-visiting customer management table 132 will be described with reference to FIG. 5.

FIG. 5 illustrates an example of the data structure of the shop-visiting customer management table 132 according to the embodiment. As illustrated in FIG. 5, the shop-visiting customer management table 132 stores a shop-visiting customer ID 132a, a distribution image 132b, the time 132c, and a distribution effect 132d in association with each other. The shop-visiting customer ID 132a indicates customer information of the customer. The shop-visiting customer ID 132a corresponds to the shop-visiting customer ID 131c of the container management table 131. The distribution image 132b indicates information for identifying the image distributed to the IoT container 4 associated with the customer. The information for identifying the image may include, for example, a name of an image or a number of the image. The time 132c indicates the time at which the image indicated by the distribution image 132b is distributed. The distribution effect 132d indicates information indicating whether or not the distribution image 132b has a new utilization or purchase effect. When there is an effect, “O” is set as an example. As an initial value of the distribution effect 132d, “-” is set as an example.

As an example, in a case where the shop-visiting customer ID 132a is “1000”, the “animation image 20” as the distribution image 132b, and the time 132c “yyyy.mm.dd.hh.mm.ss0” are stored. Also, in a case where the shop-visiting customer ID 132a is “1000”, the “discount 11” is stored as the distribution image 132b, “yyyy.mm.dd.hh.mm.ss1” is stored as the time 132c, and “O” is stored as the distribution effect 132d.

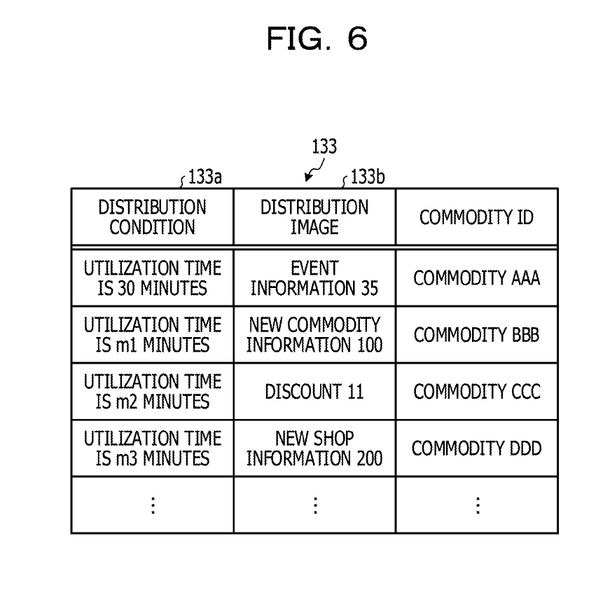

When returning to FIG. 3, the distribution rule table 133 manages distribution rules. The distribution rule table 133 may store distribution rules registered by the first terminal 2 or may store the distribution rules in advance before operation of the system. In the embodiment, a case where the distribution rule table 133 stores the distribution rules registered by the first terminal 2 will be described. Here, the data structure of the distribution rule table 133 will be described with reference to FIG. 6.

FIG. 6 illustrates an example of the data structure of the distribution rule table 133 according to the embodiment. As illustrated in FIG. 6, the distribution rule table 133 stores the distribution condition 133a, the distribution image 133b, and the commodity ID indicating the commodity for which additional purchase is urged by advertisement or the like by the distribution image 133b in association with each other. The distribution condition 133a indicates a condition under which the image is distributed. The distribution condition 133a is, for example, a condition using the utilization time that the customer utilized the shop, but the distribution condition 133a is not limited thereto, and may be a condition using the specific time or other conditions. The distribution image 133b indicates information for identifying an image to be distributed when being matched with the distribution condition 133a. The distribution image 133b corresponds to the distribution image 132b of the shop-visiting customer management table 132.

As an example, in a case where the distribution condition 133a is the “utilization time is 30 minutes”, the “event information 35” as the distribution image 133b and the commodity ID of “commodity AAA” indicating the commodity for which additional purchase is urged at the event are stored. In a case where the distribution condition 133a is the “utilization time is m1 minutes”, the “new commodity information 100” as the distribution image 133b and the commodity ID of “commodity BBB” indicating the new commodity for which additional purchase is urged are stored.

When returning to FIG. 3, the image 134 is an image to be distributed. Hereinafter, in order to distinguish the plurality of images 134, “images 134a” and an “images 134b” are described. In a case of describing without particular distinction, it is described as the “image 134”. The image 134 includes, for example, the image 134a describing an illustration and the image 134b describing a message. For example, an image of animation is included in the image 134a describing the illustration. The image 134b in which the message is described includes, for example, discount information, new commodity information, event information, new shop information, and the like. The image 134 is created or edited using the editing screen of the first terminal 2 and registered in the storing unit 13. The image 134 includes characters as well as images.

The image registration unit 121 registers the image 134 in the storing unit 13. For example, when the image 134 created by the editing screen of the first terminal 2 is received before operation of the system, the image registration unit 121 adds the image 134 to the storing unit 13. Further, when the image 134 edited by the editing screen of the first terminal 2 is received during operation of the system, the image registration unit 121 adds the image 134 to the storing unit 13 or changes the image 134.

The container association unit 122 associates the IoT container 4 with the customer in a case where utilization of the IoT container 4 is started or in a case where purchase is completed by selling the commodity to the customer.

For example, when identification information of the IoT container 4 is acquired from the first terminal 2, the container association unit 122 performs the following processing. In a case where the acquired identification information is not stored in the IoT container ID 131a of the container management table 131, the container association unit 122 determines that it is the timing at which utilization of the container indicated by the identification information is started. Then, the container association unit 122 stores identification information acquired as the IoT container ID 131a, an address corresponding to the identification information as the address 131b, and “0” as the utilization time 131d in association with each other, in the container management table 131. The address corresponding to the identification information may be held in advance in the address table.

When customer information of a customer is acquired from the POS terminal 3, the container association unit 122 stores the customer information in the shop-visiting customer ID 131c corresponding to the IoT container ID 131a which is currently stored in the container management table 131. With this, the container association unit 122 may associate the IoT container 4 with the customer. The timing to acquire the customer information of the customer may be either the timing when utilization of the IoT container 4 is started or the timing when purchase is completed.

The container utilization recording unit 123 records the lapse of time from the timing when utilization of the IoT container 4 is started. For example, the container utilization recording unit 123 activates a timer from the timing when the utilization of the IoT container 4 is started. Then, the container utilization recording unit 123 updates the utilization time 131d corresponding to the IoT container ID 131a of the container management table 131.

The image transmission unit 124 transmits an individual image to the IoT container 4 with respect to the IoT container 4.

For example, when the identification information of the IoT container 4 and the image number of the distribution image is acquired from the first terminal 2, the image transmission unit 124 transmits an image corresponding to the acquired image number in the image 134 registered in the storing unit 13 to the IoT container 4 of the transmission destination associated with the identification information. With this, the image transmission unit 124 may cause the IoT container 4 to display the individual image, for example, an image of a commodity for which additional purchase is urged.

When the identification information of the IoT container 4 is acquired, the image transmission unit 124 may cause the first terminal 2 to display an editing screen for inputting an image to be displayed on the display unit 42 of the IoT container 4. Then, when identification information of the IoT container 4 and an input distribution image are acquired from the first terminal 2, the image transmission unit 124 transmits the acquired distribution image to the IoT container 4 of the transmission destination associated with the identification information. With this, the image transmission unit 124 may cause the first terminal 2 to display the editing screen in accordance with acquisition of the identification information of the IoT container 4 to efficiently edit the image to be displayed on the IoT container 4.

When the identification information of the IoT container 4 and information of the beverage to be provided in the IoT container 4 are acquired, the image transmission unit 124 may cause the first terminal 2 to display an editing screen for inputting the information on the beverage and the image to be displayed on the display unit 42 of the IoT container 4. Then, when the identification information of the IoT container 4 and the input distribution image are acquired from the first terminal 2, the image transmission unit 124 transmits the acquired distribution image to the IoT container 4 of the transmission destination associated with the identification information. With this, the image transmission unit 124 may confirm the type of the beverage to be provided in the IoT container 4, and it is possible to efficiently input the target image to be displayed on the IoT container 4.

When the identification information of the IoT container 4 and the information of the beverage to be provided in the IoT container 4 are acquired, the image transmission unit 124 may transmit an image corresponding to information of the beverage in the image 134 registered in the storing unit 13 to the IoT container 4 of the transmission destination associated with the identification information. With this, the image transmission unit 124 may cause the IoT container 4 to display what beverage ordered by the customer is to thereby allow a customer or an employee who distributes the beverage to the customer to confirm the type of the beverage ordered by the customer.

The image transmission unit 124 also acquires the shop-visiting customer ID 131c of the customer associated with the identification information of the IoT container 4 from the container management table 131. Then, the image transmission unit 124 stores information of the transmitted image in the shop-visiting customer management table 132 in association with the acquired shop-visiting customer ID 131c.

The image change unit 125 changes an image to be displayed on the IoT container 4 according to a predetermined condition. For example, the image change unit 125 changes the image to be displayed on the IoT container 4 in accordance with the lapse of time from the timing when the utilization of the IoT container 4 is started. As an example, the image change unit 125 refers to the distribution rule table 133 and determines whether or not the utilization time 131d corresponding to the IoT container 4 in the container management table 131 conforms to the distribution condition 133a. In a case where the utilization time 131d conforms to the distribution condition 133a, the image change unit 125 transmits the distribution image 133b corresponding to the conforming distribution condition 133a to the IoT container 4 of the transmission destination associated with the IoT container 4 corresponding to the utilization time 131d. With this, the image change unit 125 may change the image to be presented to the IoT container 4 according to the lapse of time.

The image change unit 125 acquires the shop-visiting customer ID 131c of the customer associated with the identification information of the IoT container 4 from the container management table 131. Then, the image transmission unit 124 adds changed image information to the shop-visiting customer management table 132 in association with the acquired shop-visiting customer ID 131c.

The analysis unit 126 analyzes, by utilizing the image displayed on the IoT container 4, whether or not new use or purchase is performed. For example, the analysis unit 126 analyzes, based on settlement information accumulated by the POS terminal 3 and information accumulated in the shop-visiting customer management table 132, whether or not the distribution image has a new utilization or purchase effect.

As an example, it is assumed that the second terminal 5 may capture or refer to an image displayed on the display unit 42 of the IoT container 4 from a mobile application. In such a case, when the customer information of the customer and the image information of the distribution image referred to by the mobile application are acquired from the POS terminal 3, the analysis unit 126 determines whether or not the acquired image information is set in the distribution image corresponding to the customer information in the shop-visiting customer management table 132. When the acquired image information is set in the distribution image corresponding to the customer information in the shop-visiting customer management table 132, the analysis unit 126 may analyze that the distribution image has a new utilization or purchase effect. Then, the analysis unit 126 sets “O” indicating that the distribution effect 132d corresponding to the distribution image in the shop-visiting customer management table 132 has an effect. In the analysis by the analysis unit 126, for example, it is assumed that a customer additionally purchases a new beverage or utilizes the shop newly.

As another example, the analysis unit 126 may determine whether or not there is a purchase history in settlement information of a certain customer after the time 132c at which the distribution image 132b is distributed to the same customer. Specifically, based on the distribution rule table 133, the image change unit 125 transmits an image of discount information “100 yen instead of coffee” to the IoT container 4 of the customer staying for a long term. In the shop-visiting customer management table 132, the transmitted time 132c and the image information of the transmitted discount information are stored transmitted in association with the customer. After the time 132c, if the history of purchasing coffee for 100 yen for the same customer is recorded in the settlement information, the analysis unit 126 may analyze that the distribution image has the effect of new utilization or purchase. The analysis by the analysis unit 126 may be performed in real time processing or in batch processing. With this, the analysis unit 126 may analyze some effect of the distribution image.

Configuration of First Terminal 2

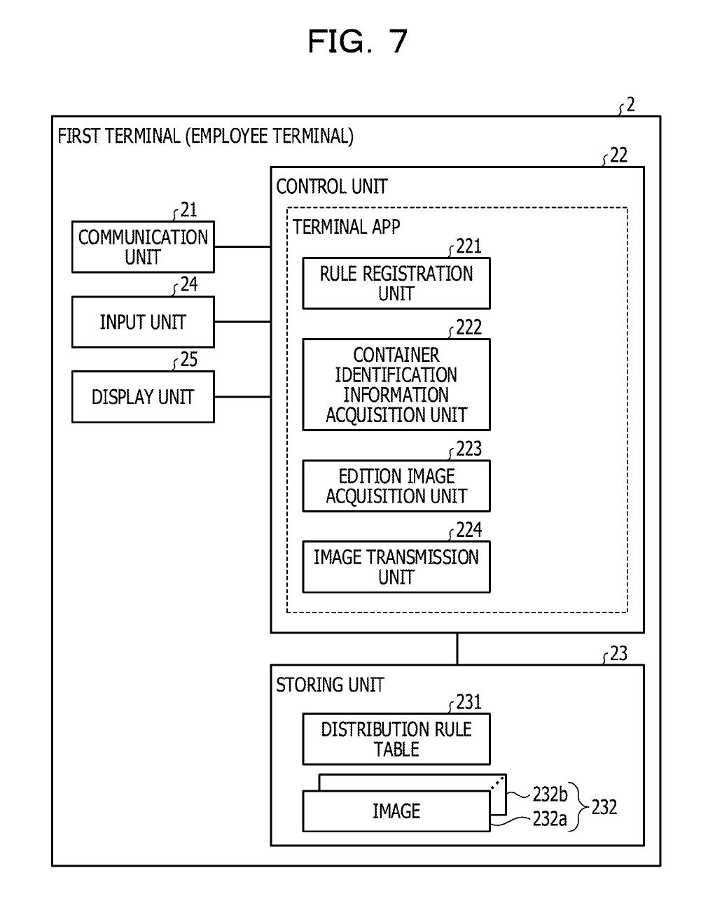

FIG. 7 illustrates a functional block diagram of the configuration of the first terminal 2 according to the embodiment. As illustrated in FIG. 7, the first terminal 2 includes a communication unit 21, a control unit 22, a storing unit 23, an input unit 24, and a display unit 25.

The communication unit 21 communicates with the IoT container management server 1 via the network 6 (see FIG. 1). The communication unit 21 is realized by, for example, an NIC or the like.

The input unit 24 receives various input operations from, for example, an employee who uses the first terminal 2. For example, the input unit 24 receives a scanning operation of the bar code attached to the IoT container 4. The input unit 24 receives an operation of selecting an image to be displayed on the display unit 42 of the IoT container 4 indicating specific identification information. The input unit 24 receives an operation of editing an image to be displayed on the display unit 42 of the IoT container 4 indicating specific identification information. As the input unit 24, for example, a keyboard, a mouse, a touch panel, or the like may be used.

The display unit 25 displays various types of information. For example, the display unit 25 displays an editing screen of the image to be displayed on the display unit 42 of the IoT container 4 indicating specific identification information, based on a request from the IoT container management server 1. The display unit 25 displays the selected image based on the selection operation from the input unit 24. The display unit 25 displays the edited image based on the edition operation from the input unit 24. As the display unit 25, for example, a display that displays various types of information may be used. The editing screen referred to here is a screen for inputting an image to be displayed on the display unit 42 of the IoT container 4 and includes an edition target area in which a predetermined area of the image may be edited. An example of a screen configuration of the editing screen will be described later.

The control unit 22 corresponds to an electronic circuit such as a CPU. The control unit 22 includes an internal memory for storing programs defining various processing procedures and control data, and executes various processes by these programs and control data. Here, it is assumed that the control unit 22 executes processing with a terminal application corresponding to the server application. The control unit 22 includes a rule registration unit 221, a container identification information acquisition unit 222, an edition image acquisition unit 223, and an image transmission unit 224.

The storing unit 23 is, for example, a semiconductor memory element such as a RAM or a flash memory, or a storage device such as a hard disk or an optical disk. The storing unit 23 has a distribution rule table 231 and an image 232.

The distribution rule table 231 stores distribution rules. Since the distribution rule table 231 is similar to the distribution rule table 133 of the IoT container management server 1, description thereof will be omitted.

The image 232 is an image to be displayed on the display unit 42 of the IoT container 4. Hereinafter, a plurality of the images 232 are described as “image 232a” and “image 232b” in order to distinguish the images 232. The “image 232a” and “image 232b” are described as the “image 232” when describing without distinction. Since the image 232 is similar to the image 134 of the IoT container management server 1, description thereof will be omitted.

The rule registration unit 221 registers the distribution rule. For example, the rule registration unit 221 registers the distribution condition and the distribution image input from the employee in the distribution rule table 231 in association with each other. Then, the rule registration unit 221 transmits the distribution rule table 231 to the IoT container management server 1 so as to be stored in the IoT container management server 1.

The container identification information acquisition unit 222 acquires identification information of the IoT container 4. For example, the container identification information acquisition unit 222 acquires the bar code indicating the identification information of the IoT container 4 from the input unit 24 as identification information. Then, the container identification information acquisition unit 222 transmits the acquired identification information to the IoT container management server 1.

The edition image acquisition unit 223 acquires the input image using the editing screen. For example, regarding the image to be displayed on the display unit 42 of the IoT container 4 corresponding to the identification information, the edition image acquisition unit 223 acquires the image or an image number of the image input by using the editing screen. With this, the employee using the first terminal 2 may input or edit an image to be displayed on the display unit 42 of the IoT container 4 according to individual information of the customer associated with the IoT container 4 and the situation in the shop. Individual information for the customer includes, for example, an age and atmosphere of the shop-visiting customer. A situation in the shop for the customer includes, for example, the utilization time for the customer to utilize the shop.

The image transmission unit 224 transmits information of the image to the IoT container management server 1. For example, the image transmission unit 224 transmits the image acquired by the edition image acquisition unit 223 or the image number of the image together with the identification information of the IoT container 4 to the IoT container management server 1.

Configuration of POS terminal 3

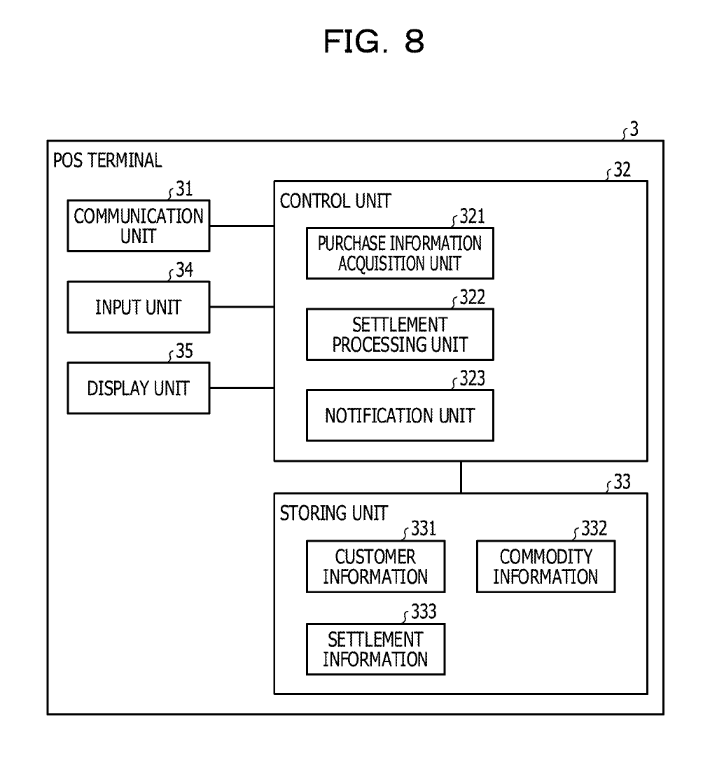

FIG. 8 illustrates a functional block diagram of the configuration of the POS terminal 3 according to the embodiment. As illustrated in FIG. 8, the POS terminal 3 includes a communication unit 31, a control unit 33, a storing unit 32, an input unit 34, and a display unit 35.

The communication unit 31 communicates with the IoT container management server 1 via the network 6 (see FIG. 1). The communication unit 31 is realized by, for example, an NIC or the like.

The input unit 34 receives various input operations from, for example, an employee who uses the POS terminal 3. For example, the input unit 34 receives a bar code scanning operation for a shop specific prepaid card presented by a customer or a shop specific application screen displayed on the second terminal 5 which is a terminal for the customer. Further, the input unit 34 receives an input operation for a commodity code (commodity ID) indicating a commodity to be purchased by a customer, a quantity, and the like. As the input unit 34, for example, a keyboard, a mouse, a touch panel, a handy scanner, or the like may be used.

The display unit 35 displays various types of information. For example, the display unit 35 reads and displays customer information 331 identified by the bar code scanning operation for the shop specific prepaid card presented by the customer or the shop specific application screen displayed on the second terminal 5 which is the terminal for the customer. The display unit 35 displays information such as commodity information 332, a purchase quantity, a purchase price, and the like corresponding to the commodity ID input as a commodity to be purchased by the customer.

The control unit 32 corresponds to an electronic circuit such as a CPU. The control unit 32 includes an internal memory for storing programs defining various processing procedures and control data, and executes various processing by these programs and control data. Here, the control unit 32 includes a purchase information acquisition unit 321, a settlement processing unit 322, and a notification unit 323.

The storing unit 33 is, for example, a semiconductor memory element such as a RAM or a flash memory, or a storage device such as a hard disk or an optical disk. The storing unit 33 stores customer information 331, commodity information 332, and settlement information 333.

The customer information 331 is information for each customer. For example, the customer information 331 includes the name, sex, age, address, payment information, and the like, together with identification information (shop-visiting customer ID) assigned to each customer. The payment information is information such as a prepaid card or a credit card used for payment at the time of settlement. The POS terminal 3 refers to the payment information of the customer information 331 based on identification information that identifies the customer to thereby perform settlement of the commodity purchased by the customer.

The commodity information 332 is information for each commodity. For example, the commodity information 332 includes a commodity name, a commodity category, a unit price (selling price), and the like, together with identification information (commodity ID) assigned to each commodity.

The settlement information 333 is information indicating settlement details for each settlement. For example, the settlement information 333 includes the identified customer information (shop-visiting customer ID), the commodity name (commodity ID) and quantity, the price, the purchase time, the identification information of the IoT container 4 corresponding to the customer, and the like.

The purchase information acquisition unit 321 acquires information (for example, customer information, IoT container ID, commodity and quantity to be purchased, and the like) when the customer purchases the commodity. For example, the purchase information acquisition unit 321 identifies customer's customer information (shop-visiting customer ID) from the bar code of the shop specific prepaid card presented by the customer or the shop specific application screen displayed on the second terminal 5, which is input by the input unit 34. The purchase information acquisition unit 321 acquires the commodity code (commodity ID) indicating the commodity to be purchased by the customer, the quantity, and the like from the input unit 34. The purchase information acquisition unit 321 acquires the IoT container ID and the purchase request received from the IoT container 4 via the communication unit 31.

The settlement processing unit 322 performs settlement processing for settling sales transaction with respect to the commodity (for example, beverage) that the customer purchases, and registers settled contents in the settlement information 333.

For example, if information (for example, customer information, IoT container ID, commodity and quantity to be purchased, and the like) when the customer purchases the commodity is acquired from the purchase information acquisition unit 321, the settlement processing unit 322 identifies the customer information 331 of the customer who purchases the commodity. Next, based on payment information of the identified customer information 331, the settlement processing unit 322 settles purchase transaction of the commodity purchased by the customer and registers (stores) settlement details in the settlement information 333.

When the IoT container ID and the purchase request are received from the IoT container 4, the settlement processing unit 322 executes settlement processing concerning purchase of the commodity corresponding to the purchase request by using the settlement information 333 stored in the storing unit 33. Specifically, the settlement processing unit 322 specifies the settlement information 333 of the customer corresponding to the IoT container 4 based on the IoT container ID notified from the IoT container 4. Next, the settlement processing unit 322 identifies the customer information 331 of the customer who made the purchase request is made, based on the customer identification information (shop-visiting customer ID) included in the specified settlement information 333. Next, based on the payment information of the identified customer information 331, the settlement processing unit 322 settles the purchase transaction of the commodity that the customer has requested to purchase and registers (stores) the settlement details in the settlement information 333.

The notification unit 323 makes various notifications based on settlement by the settlement processing unit 322 to the IoT container management server 1, the first terminal 2, and the IoT container 4 via the communication unit 31. For example, the notification unit 323 transmits the customer information of the customer to the IoT container management server 1 in order to make the customer correspond to the IoT container 4 which is the container of the commodity purchased by the customer.

In a case where settlement by the purchase request from the IoT container 4 is completed, the notification unit 323 notifies the purchased commodity to the first terminal 2 and the IoT container 4. For example, the first terminal 2 is notified of settlement contents based on a purchase request from the IoT container 4 (for example, customer information 331 corresponding to a shop-visiting customer ID, commodity name, IoT container ID, and the like). The first terminal 2 displays contents notified by the notification unit 323 on the display unit 25. With this, the employee using the first terminal 2 may prepare the commodity for which the purchase request is made and distribute the commodity to the customer.

The notification unit 323 notifies an image (for example, commodity appearance, commodity name, and the like) of the purchased commodity to the IoT container 4. The display unit 42 of the IoT container 4 displays the image of the purchased commodity. With this, a customer or an employee who distributes a settled commodity may confirm the purchased commodity by confirming the display unit 42 of the IoT container 4.

Image Displayed on Display Unit 42 of IoT Container 4

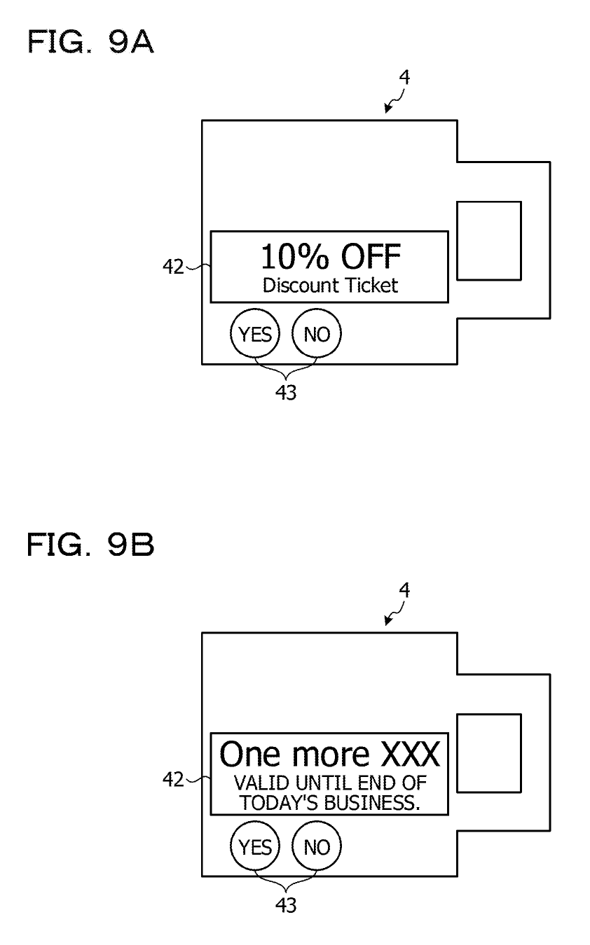

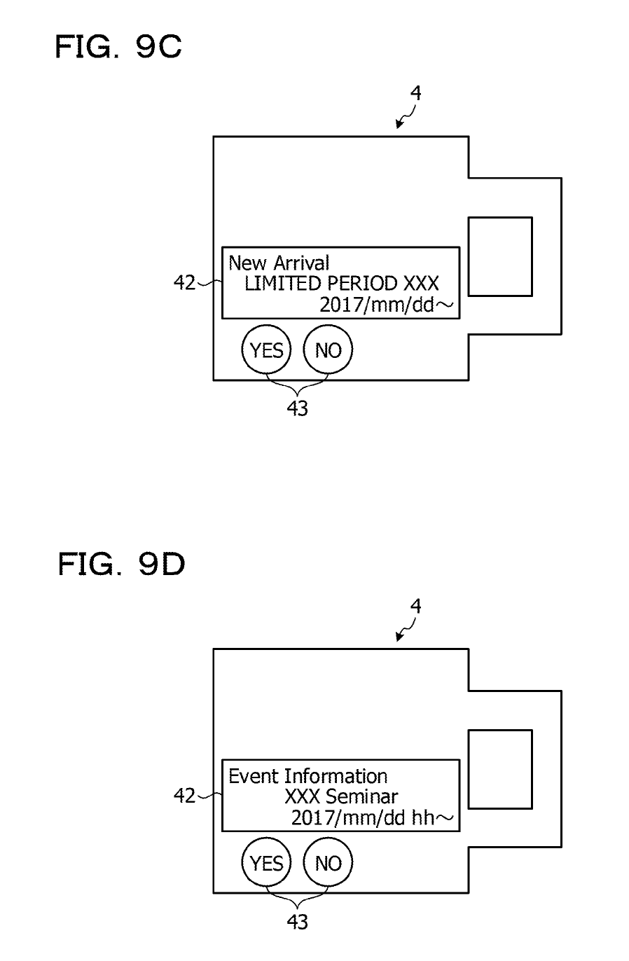

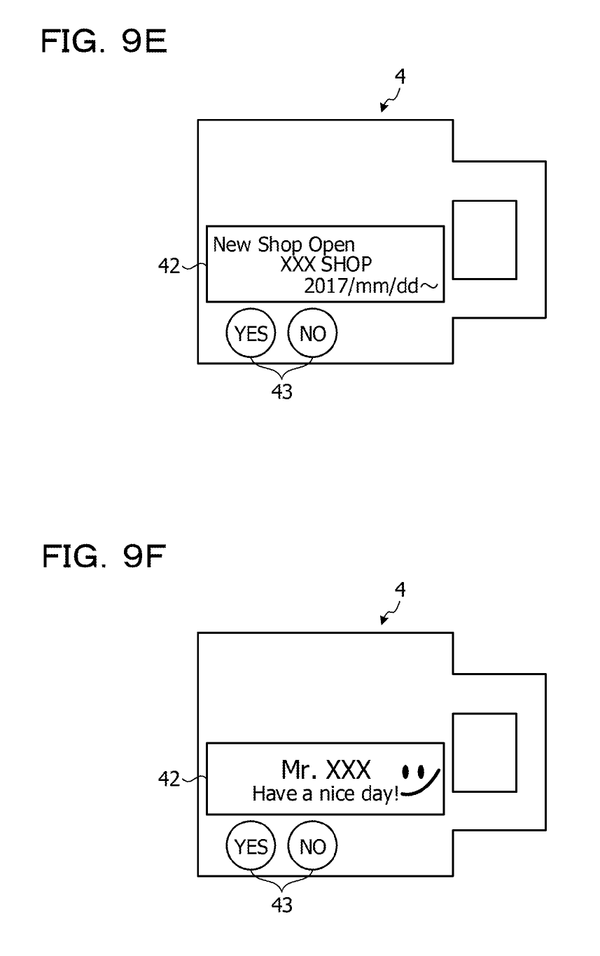

Next, an example of an image displayed on the display unit 42 of the IoT container 4 will be described with reference to FIGS. 9A to 9F. FIG. 9A illustrates an example of an image displayed on the display unit 42 of the IoT container 4. As illustrated in FIG. 9A, an image illustrating discount information is displayed on the IoT container 4. Here, “10% OFF” is displayed as discount information. For example, when the utilization time corresponding to the IoT container ID of the IoT container 4 has elapsed a predetermined time based on the shop-visiting customer management table 132, the image change unit 125 displays a distribution image illustrating the discount information on the display unit 42 of the IoT container 4. Then, in the IoT container 4, the reaction of the customer to “10% OFF” displayed on the display unit 42 by the operation unit 43 is received.

FIGS. 9B to 9F illustrate other examples of the image displayed on the display unit 42 of the IoT container 4. As illustrated in FIG. 9B, on the display unit 42, an image indicating an advertisement urging for additional purchase of a commodity is displayed. Here, “One more XXX valid until the end of today's business” is displayed as information indicating the advertisement. The customer may notify additional purchase of the commodity “XXX” by operating a button of the operation unit 43 (pressing operation of “YES” button).

As illustrated in FIG. 9C, an image indicating an advertisement is displayed on the display unit 42 of the IoT container 4. Here, “New Arrival limited period XXX 2017/mm/dd˜” is displayed as information indicating the advertisement. The customer may notify the reaction to the displayed “New Arrival limited period XXX 2017/mm/dd˜” by the operating the button of the operation unit 43.

As illustrated in FIG. 9D, on the display unit 42 of the IoT container 4, an image illustrating event information is displayed. Here, as the event information, “Event Information XXX Seminar 2017/mm/dd hh˜” is displayed. The customer may notify the reaction to the displayed “Event Information XXX Seminar 2017/mm/dd hh˜” by the button operation of the operation unit 43.

As illustrated in FIG. 9E, on the display unit 42 of the IoT container 4, an image illustrating information on a new shop is displayed. Here, “New Shop Open XXX shop 2017/mm/dd˜” is displayed as information of the new shop. The customer may notify the reaction to the displayed “New Shop Open XXX shop 2017/mm/dd˜” by operating the button of the operation unit 43.

As illustrated in FIG. 9F, on the display unit 42 of the IoT container 4, an image illustrating individual information on other IoT containers 4 is displayed. Here, “Mr. XXX, Have a nice day!” is displayed as individual information of the IoT container 4. The customer may notify the reaction to the displayed “Mr. XXX, Have a nice day!” operating the button of the operation unit 43.

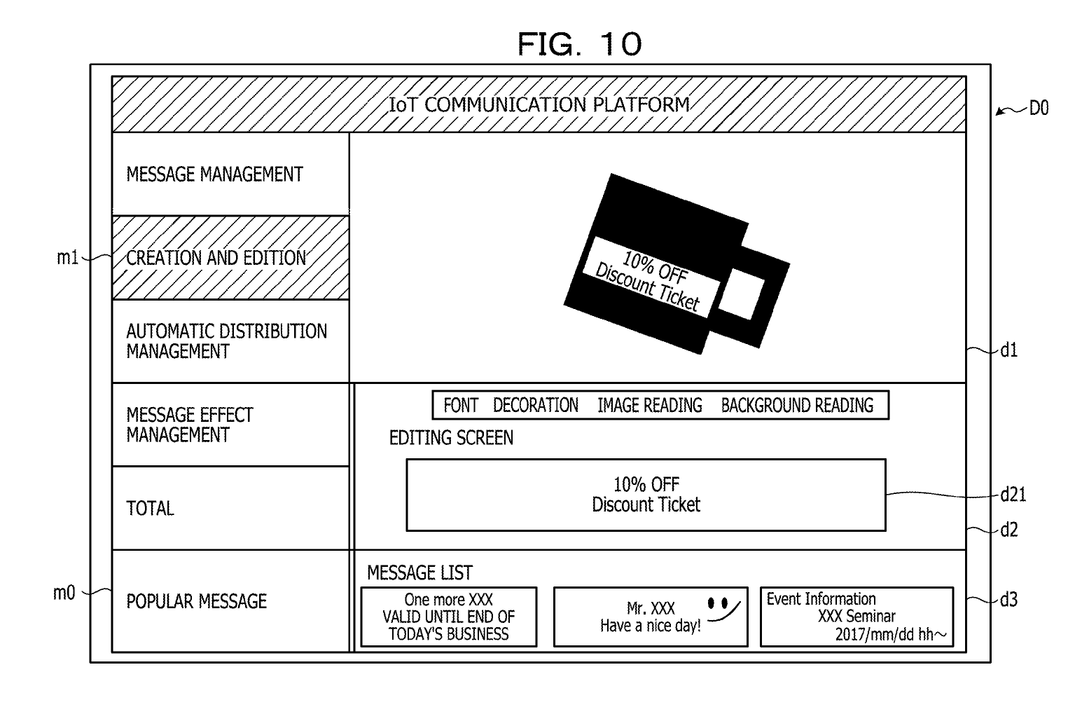

Editing Screen Displayed On Display Unit 25 Of First Terminal 2 Next, an example of an editing screen displayed on the display unit 25 of the first terminal 2 will be described with reference to FIG. 10. FIG. 10 is a diagram illustrating an example of the editing screen of the first terminal 2. As illustrated in FIG. 10, an IoT communication platform screen DO is represented as an example of a screen including a display screen. The IoT communication platform screen DO includes a menu screen m0. When the creation and edition button m1 in the menu screen m0 is selected, a screen d1 for displaying an image view of the IoT container 4, an editing screen d2, and a message list screen d2 are displayed. The editing screen d3 includes an edition target area d21 in which a predetermined area of an image to be displayed on the display unit 42 of the IoT container 4 may be edited. For example, the employee may edit the image to be displayed on the display unit 42 of the specific IoT container 4 in the edit target area d21 of the editing screen d2 while appropriately referring to the screen d3 of the message list. The employee may confirm the image displayed on the IoT container 4 on the screen d1 every time of editing.

Processing Sequence of Shop System 9

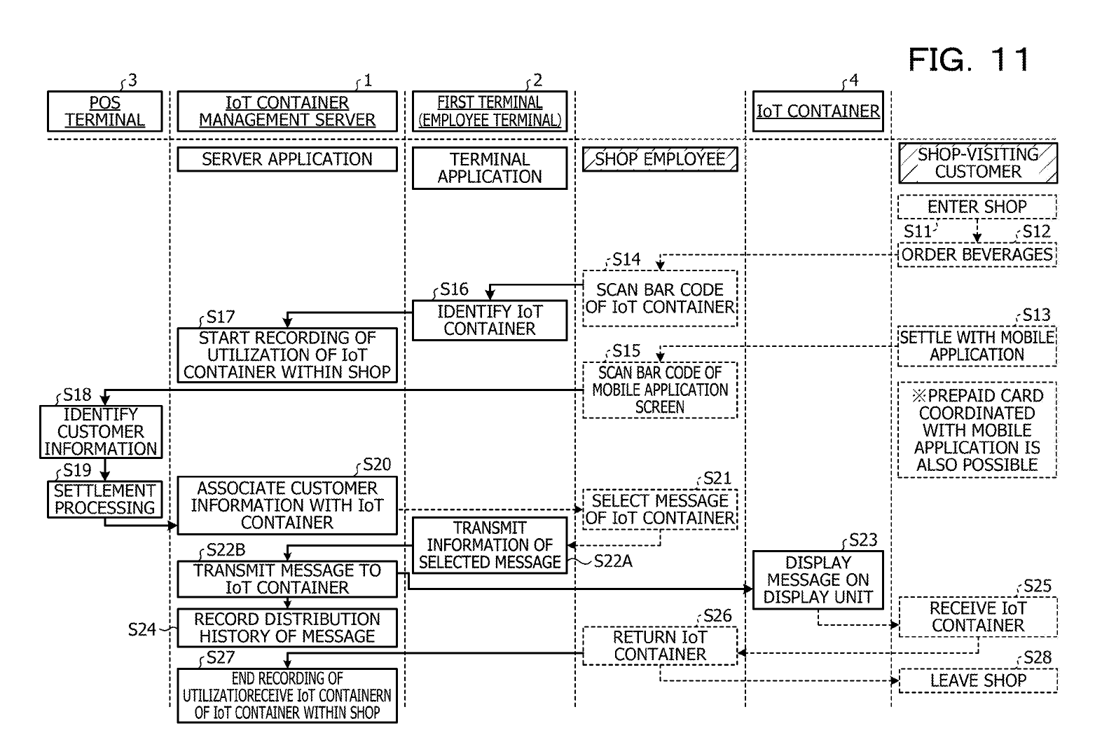

FIGS. 11 to 13 are explanatory diagrams for explaining a flow of processing of the shop system 9 according to the embodiment. In FIG. 11, a case where an employee selects an image of each shop-visiting customer, and the IoT container management server 1 displays the selected image on the IoT container 4 corresponding to the shop-visiting customer when a shop-visiting customer (customer) orders a beverage will be described. The broken line in FIG. 10 indicates processing performed by a human being.

As illustrated in FIG. 11, the shop-visiting customer enters the shop and orders a beverage (S11 and S12). Then, the shop-visiting customer settles with a mobile application installed in a possessed second terminal 5 (S13). The settlement may be carried out by a prepaid card already coordinated with the mobile application instead of the mobile application.

The employee of the shop that received the order for the beverage scans a bar code attached to the IoT container 4 (S14). The bar code read from the IoT container 4 is identification information of the IoT container 4. The employee scans the bar code of the mobile application screen (S15). The bar code read from the mobile application screen is the customer information of the shop-visiting customer.

The first terminal 2 which has received the operation of the bar code attached to the IoT container 4 acquires the bar code and identifies the IoT container 4 (S16). Then, the first terminal 2 transmits the acquired bar code to the IoT container management server 1.

The IoT container management server 1 which has received the bar code starts recording of utilization of the IoT container 4 corresponding to the bar code within the shop (S17). That is, the IoT container management server 1 records the lapse of time from the timing when the utilization of the IoT container 4 is started. For example, since the bar code is not stored in the IoT container ID 131a of the container management table 131, the IoT container management server 1 determines that it is the timing at which utilization of the IoT container 4 is started. Then, the IoT container management server 1 stores the bar code, the address corresponding to the bar code, “0” as the utilization time in the container management table 131 in association with each other. Then, the IoT container management server 1 activates a timer corresponding to the bar code, and records the lapse of the time from the timing when the utilization of the IoT container 4 is started.

On the other hand, the POS terminal 3 which has accepted the scanning operation of the bar code on the mobile application screen acquires the bar code and identifies customer information indicating the shop-visiting customer (S18). Then, the POS terminal 3 performs settlement processing (S19). Then, the POS terminal 3 transmits the acquired customer information to the IoT container management server 1.

The IoT container management server 1 which has received the customer information associates the customer information with the IoT container 4 of which utilization is started (S20). For example, the IoT container management server 1 stores the customer information in the shop-visiting customer ID 131c corresponding to the IoT container ID 131a in the container management table 131. The IoT container management server 1 notifies identification information (IoT container ID 131a) of the IoT container 4 corresponding to the customer information to the POS terminal 3. With this, the POS terminal 3 registers the settlement information 333 registered in settlement processing and the identification information of the IoT container 4 corresponding to the settled customer in association with each other.

The employee of the shop selects a message to be displayed on the display unit 42 of the IoT container 4 associated with the shop-visiting customer (S21). For example, selection of a message is selected using an editing screen.

The first terminal 2 that has received information of the message transmits the information of the message and the identification information of the IoT container 4 to the IoT container management server 1 (S22A) and the IoT container management server 1 transmits the message to the IoT container 4 at the address associated with the identification information (S22B). The information of the message may be the message itself or the number of the message. The message may be an image or characters.

The IoT container 4 that has received the message displays a message on the display unit 42 (S23). On the other hand, the IoT container management server 1 that has transmitted the message records the information of the message transmitted to the IoT container 4 in the shop-visiting customer management table 132 as a distribution history (S24). For example, the IoT container management server 1 acquires the customer information of the shop-visiting customer associated with the identification information of the IoT container 4 from the container management table 131. Then, the IoT container management server 1 adds information of the transmitted message to the shop-visiting customer management table 132 in association with the acquired customer information.

Then, the shop-visiting customer receives the IoT container 4 containing the commodity (beverage) (S25).

Thereafter, the employee of the shop receives the IoT container 4 after use from the shop-visiting customer and returns the IoT container 4 (S26).

The IoT container management server 1 which has received the return of the IoT container 4 ends recording of utilization of IoT container within the shop for the returned IoT container 4 (S27). For example, the IoT container management server 1 stops the timer corresponding to the identification information of the IoT container 4, and ends recording of the lapse of time. On the other hand, the shop-visiting customer for whom the return of the IoT container 4 has received leaves the shop (S28).

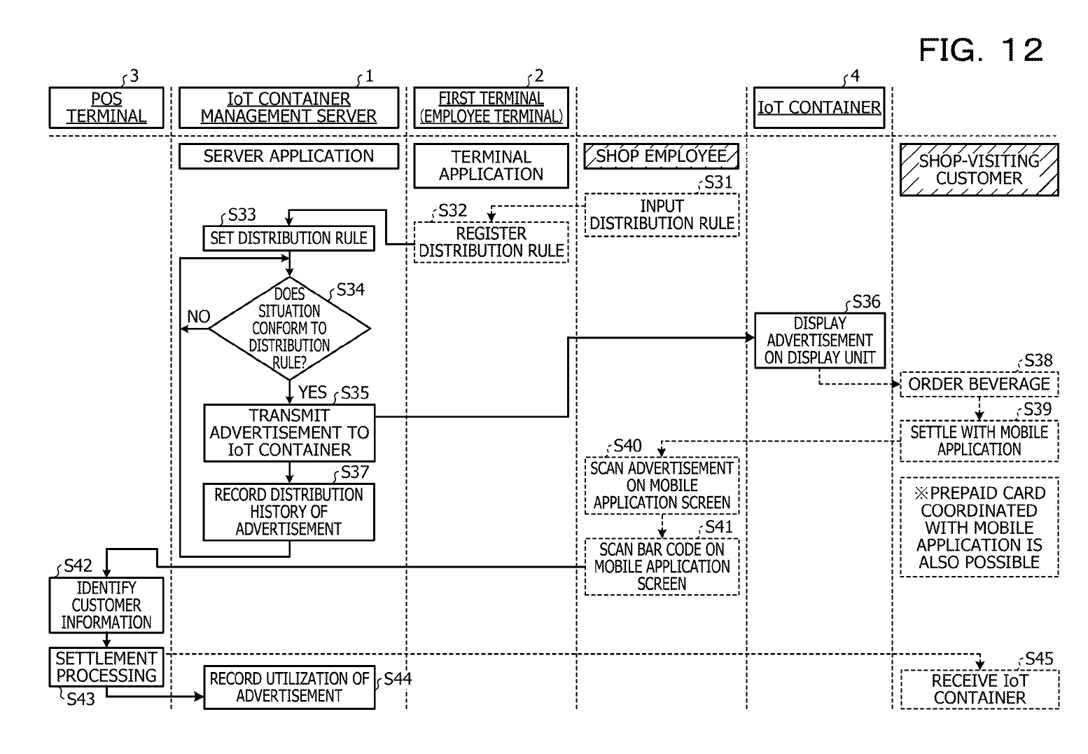

In FIG. 12, a case where the IoT container management server 1 specifies the image of the advertisement corresponding to the conforming distribution rule when the situation within the shop of the shop-visiting customer conforms to the distribution rule and causes the specified image to be displayed on the IoT container 4 corresponding to the shop-visiting customer will be described. The broken line in FIG. 12 indicates processing performed by a human.

As illustrated in FIG. 12, the first terminal 2 that has received the distribution rule input by the employee of the shop registers the received distribution rule in the distribution rule table 231 (S31 and S32). For example, the first terminal 2 registers the distribution rule associating the distribution condition and the distribution image of the advertisement in the distribution rule table 231 (S32). Then, the first terminal 2 transmits the registered distribution rule to the IoT container management server 1.

The IoT container management server 1 which has received the distribution rule sets the received distribution rule in the distribution rule table 133 of the storing unit 13 (S33). Thereafter, the IoT container management server 1 refers to the distribution rule table 133 and determines whether or not the situation within the shop of the shop-visiting customer conforms to the distribution rule (S34). For example, the IoT container management server 1 refers to the distribution rule table 133 and determines whether or not the utilization time 131d corresponding to the IoT container 4 in the container management table 131 conforms to the distribution condition 133a.

In a case where it is determined that the situation in the shop of the shop-visiting customer does not conform to the distribution rule (No in S34), the IoT container management server 1 causes processing to proceed to S34. On the other hand, in a case where it is determined that the situation in the shop of the shop-visiting customer conforms to the distribution rule (Yes in S34), the IoT container management server 1 transmits an advertisement indicating the distribution image corresponding to the conforming distribution rule to the IoT container 4 at the address 131b corresponding to the utilization time 131d (S35).

The IoT container 4 that has received the message displays an advertisement on the display unit 42 (S36). On the other hand, the IoT container management server 1 that has transmitted the message records the advertisement information transmitted to the IoT container 4 as a history in the shop-visiting customer management table 132 (S37). For example, the IoT container management server 1 acquires the customer information of the shop-visiting customer associated with the identification information of the IoT container 4 from the container management table 131. Then, the IoT container management server 1 adds information of the transmitted advertisement to the shop-visiting customer management table 132 in association with the customer information.

Thereafter, it is assumed that the shop-visiting customer has ordered a beverage (S38). Then, the shop-visiting customer performs settlement with the mobile application installed in the possessed second terminal 5 (S39). The settlement may be carried out by a prepaid card already coordinated with the mobile application instead of the mobile application.

The employee of the shop that has received the order of the beverage scans the advertisement on the mobile application screen (S40). It is assumed that the advertisement read from the mobile application screen is information obtained by fetching or referring to the advertisement displayed on the IoT container 4. The employee scans the bar code on the mobile application screen (S41). The bar code read from the mobile application screen is the customer information of the shop-visiting customer.

The POS terminal 3 that has received the scanning operation of the bar code on the mobile application screen and the scanning operation of the advertisement acquires the bar code and identifies the customer information indicating the shop-visiting customer (S42). Then, the POS terminal 3 performs settlement processing (S43). Then, the POS terminal 3 transmits the acquired customer information and advertisement information to the IoT container management server 1.

The IoT container management server 1 which has received the customer information and the advertisement information records utilization of the advertisement (S44). For example, when information of the received advertisement is set in the distribution image corresponding to the customer information in the shop-visiting customer management table 132, the IoT container management server 1 sets “O” indicating that there is an effect in the distribution effect 132d corresponding to the distribution image.

On the other hand, when settlement processing is completed, the shop-visiting customer receives the IoT container 4 (S45). Thereafter, until the shop-visiting customer leaves the shop, the shop system 9 repeats processing of S33 to S45.

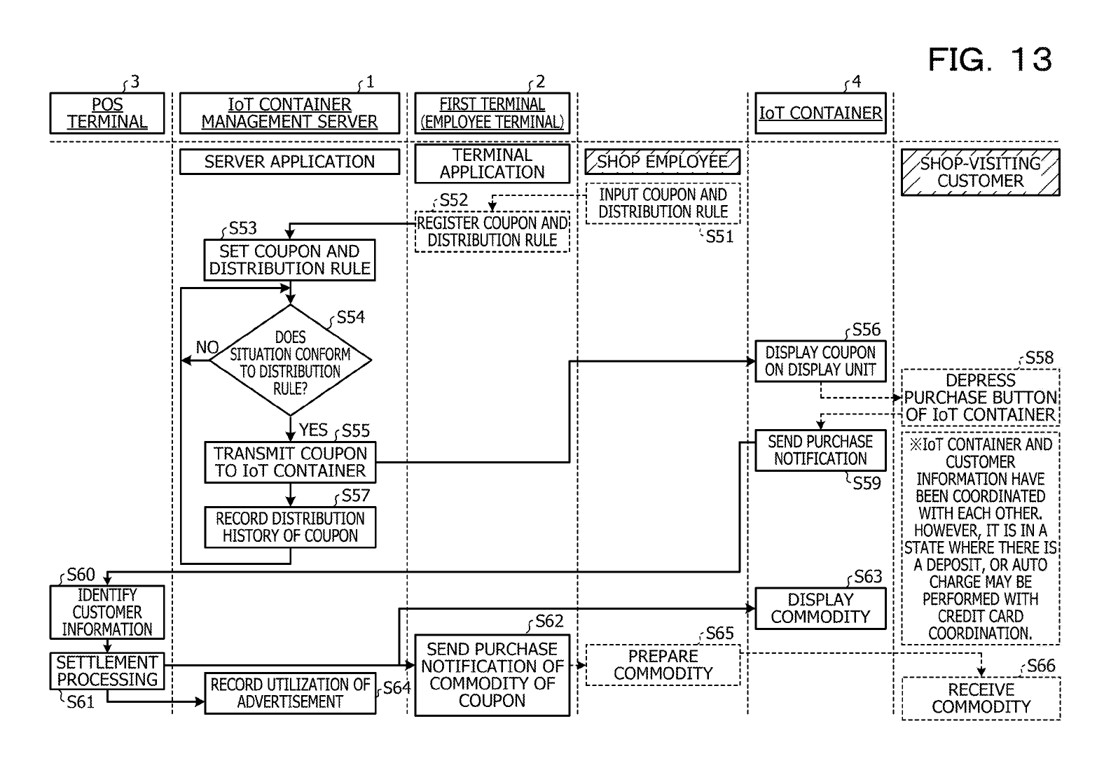

In FIG. 13, the IoT container management server 1 specifies an image illustrating a coupon of the commodity corresponding to the conforming distribution rule in a case where the situation in the shop of the shop-visiting customer conforms to the distribution rule, and causes the specified image to be displayed on the IoT container 4 corresponding to the shop-visiting customer. A case where the shop-visiting customer requests a commodity relating to the coupon displayed on the IoT container 4 by operating the operation unit 43 will be described. The broken line in FIG. 13 is processing performed by a human being.

As illustrated in FIG. 13, the first terminal 2 that has received the coupon for the commodity input by the employee of the shop and the distribution rule registers the received coupon and distribution rule in the distribution rule table 231 (S51 and S52). For example, the first terminal 2 registers the distribution rule associating the distribution condition, the distribution image of the advertisement, and the commodity ID of the commodity in the distribution rule table 231 (S52). Then, the first terminal 2 transmits the registered distribution rule to the IoT container management server 1.

The IoT container management server 1 which has received the distribution rule sets the received distribution rule in the distribution rule table 133 of the storing unit 13 (S53). Thereafter, the IoT container management server 1 refers to the distribution rule table 133 and determines whether or not the situation in the shop of the shop-visiting customer conforms to the distribution rule (S54). For example, the IoT container management server 1 refers to the distribution rule table 133 and determines whether or not the utilization time 131d corresponding to the IoT container 4 in the container management table 131 conforms to the distribution condition 133a.

In a case where it is determined that the situation in the shop of the shop-visiting customer does not conform to the distribution rule (No in S54), the IoT container management server 1 causes processing to proceed to S54. On the other hand, in a case where it is determined that the situation within the shop of the shop-visiting customer conforms to the distribution rule (Yes in S54), the IoT container management server 1 transmits the coupon (advertisement indicating the distribution image) corresponding to the conforming distribution rule to the IoT container 4 at the address 131b corresponding to the utilization time 131d (S55).

The IoT container 4 that has received the message displays the coupon on the display unit 42 (S56). On the other hand, the IoT container management server 1 that has transmitted the message records information of the coupon transmitted to the IoT container 4 as a history in the shop-visiting customer management table 132 (S57). For example, the IoT container management server 1 acquires the customer information of the shop-visiting customer associated with the identification information of the IoT container 4 from the container management table 131. Then, the IoT container management server 1 adds the information of the transmitted coupon to the shop-visiting customer management table 132 in association with the customer information.

Thereafter, it is assumed that the shop-visiting customer has instructed a purchase request for the commodity of the coupon by depressing the purchase button (“YES” button) in the operation unit 43 (S58). It is assumed that the IoT container 4 and customer information have already been coordinated with each other by the flow illustrated in FIG. 11. However, it is assumed that it is in a state where there is a deposit by the prepaid card or auto charge may be performed with credit card cooperation.

The IoT container 4 sends a purchase notification (purchase request) on the commodity of the coupon to the POS terminal 3 together with the IoT container ID by the operation of depressing the purchase button (S59).

The POS terminal 3 identifies the settlement information 333 of the customer corresponding to the IoT container 4 based on the IoT container ID notified from the IoT container 4 (S60). Next, the POS terminal 3 identifies the customer information 331 of the customer who has received the purchase notification, based on the identification information of customer (shop-visiting customer ID) included in the settlement information 333, and performs settlement processing of the commodity for which purchase notification has been sent using the customer information 331 (S61).

In a case where the settlement processing is completed, the POS terminal 3 notifies the purchased commodity to the first terminal 2 and the IoT container 4 (S62 and S63). With this, at the first terminal 2, a purchase notification regarding the purchased commodity of the coupon is displayed on the input unit 24 (S62). Also, the purchased commodity is displayed on the display unit 42 of the IoT container 4 (S63).

The POS terminal 3 transmits the acquired customer information and advertisement information to the IoT container management server 1. The IoT container management server 1 which has received the customer information and advertisement information records utilization of the advertisement (S64). For example, the IoT container management server 1 sets “O” indicating that there is a purchase request (with advertisement effect) in the distribution image corresponding to the customer information in the shop-visiting customer management table 132 in the distribution effect 132d. With this, the shop side may determine whether or not advertisement information was effective.

Next, the employee of the shop who has confirmed the purchase notification from the first terminal 2 prepares the commodity (S65) and distributes the commodity to the shop-visiting customer. With this, the shop-visiting customer may receive the commodity without going to the register counter (S66).

Use of Shop System 9

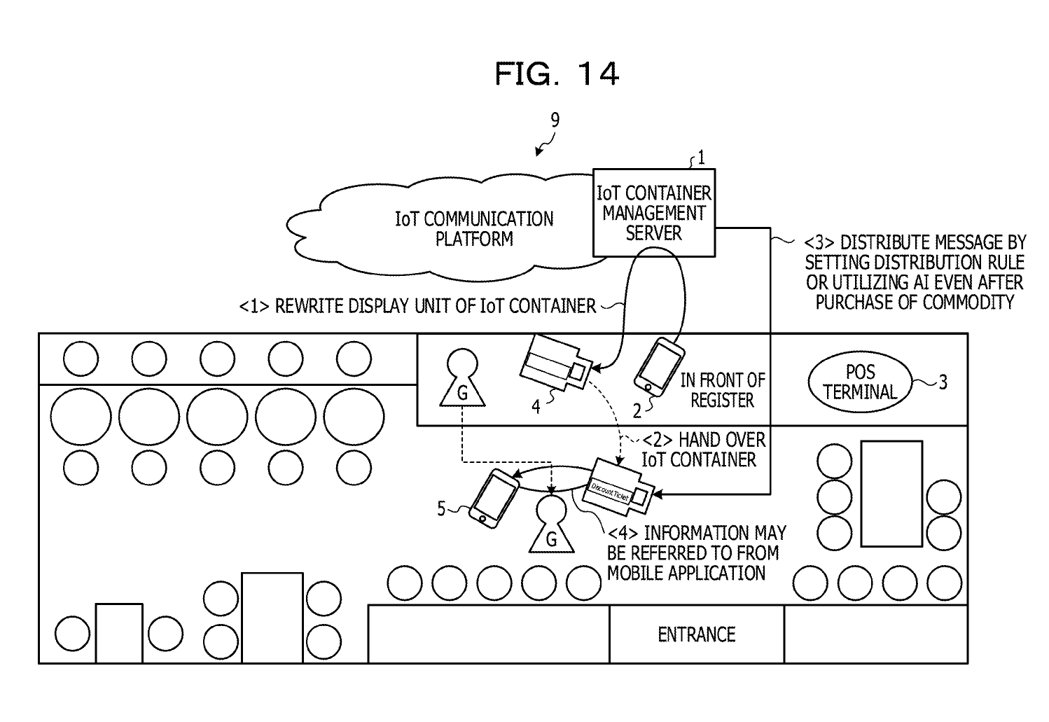

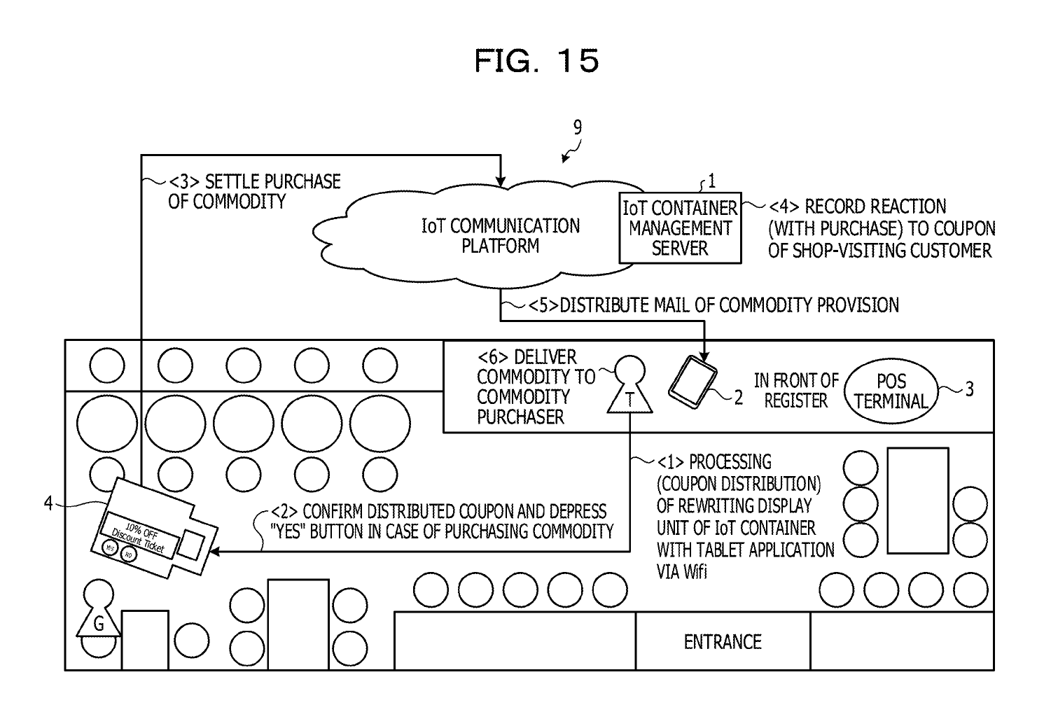

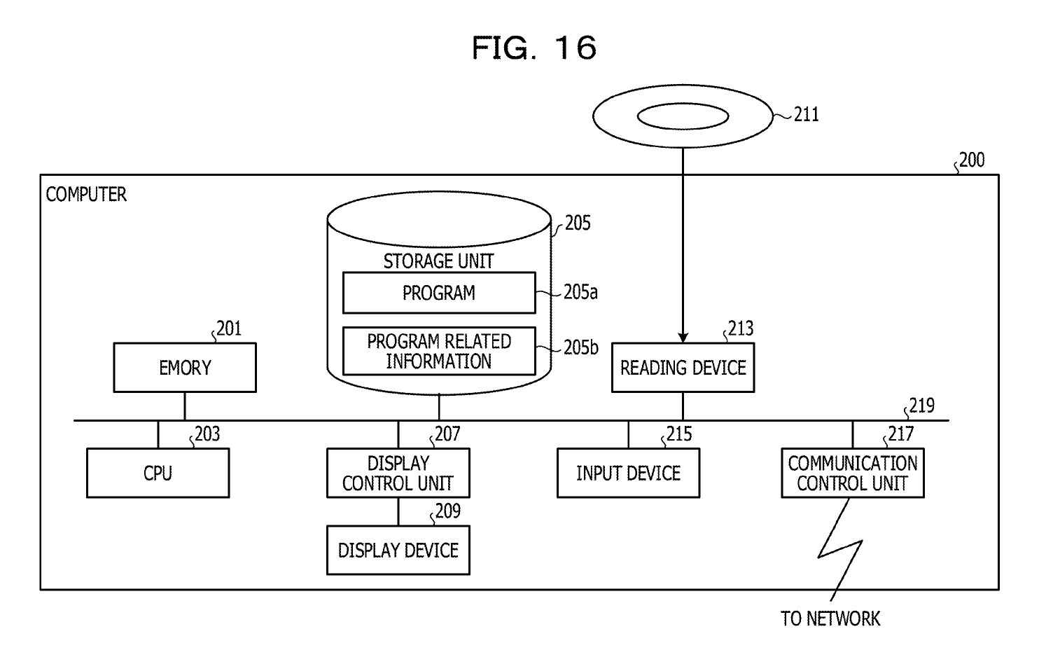

FIGS. 14 and 15 illustrate examples of use of the shop system 9 according to the embodiment. FIGS. 14 and 15 illustrate an example of a shop of a restaurant. The IoT container management server 1 is connected to each of the IoT container 4, the first terminal 2 positioned in front of the register, and the POS terminal 3 by WiFi. Then, the IoT container 4 is connected to the second terminal 5 by BLE. In FIGS. 14 and 15, description will be made by paying attention to a shop-visiting customer G among a plurality of shop-visiting customers.

As illustrated in FIG. 14, when the shop-visiting customer G orders a beverage, the employee scans the bar code of the IoT container 4 that contains beverage using the first terminal 2 and scans the bar code on the mobile application screen of the second terminal 5 of the shop-visiting customer G using the POS terminal 3. The IoT container management server 1 which has received the bar code (identification information) on the IoT container 4 and the bar code (customer information) on the mobile application screen associates the IoT container 4 with the shop-visiting customer G. <1> The employee rewrites the display unit 42 of a target IoT container 4 via WiFi, for example, from shop-visiting customer information such as the age and atmosphere of the shop-visiting customer G, using the terminal application of the first terminal 2. <2> The employee hands over the IoT container 4 containing the ordered beverage. <3> Thereafter, in order to display a message on the display unit 42 of the target IoT container 4, for example, by setting the distribution rule or utilizing the artificial intelligence (AI), the IoT container management server 1 distributes the message to the target IoT container 4 via WiFi. <4> The shop-visiting customer G may refer to the information displayed on the display unit 42 from the mobile application of the second terminal 5.

With this, the shop system 9 may display an appropriate message to the IoT container 4 associated with the shop-visiting customer G according to the shop-visiting customer information of the shop-visiting customer G and the situation within the shop of the shop-visiting customer G.

As illustrated in FIG. 15, <1> the employee T rewrites the display unit 42 of a target IoT container 4 via WiFi, for example, from shop-visiting customer information such as the age and atmosphere of the shop-visiting customer G, using the terminal application of the first terminal 2, and distributes the coupon for the commodity. <2> The shop-visiting customer G confirms the coupon distributed to the IoT container 4 and displayed on the display unit 42, and depresses the “YES” button of the operation unit 43 in a case of purchasing the commodity. <3> When the POS terminal 3 is notified of the purchase of the commodity from the IoT container 4, the POS terminal 3 performs settlement for the purchase of the commodity. <4> In response to notification from the POS terminal 3 after completion of the settlement, the IoT container management server 1 records the reaction (with purchase) to the coupon of the shop-visiting customer G. <5> After completion of the settlement, the POS terminal 3 notifies the purchased commodity to the first terminal 2 by e-mail distribution or the like urging provision of the settled commodity. <6> The employee T prepares the notified commodity and distributes the commodity to a commodity purchaser (shop-visiting customer G).

With this, the shop-visiting customer G may purchase the commodity without going to the register counter. As such, the shop system 9 may reduce time and effort of the shop-visiting customer G at the time of purchasing the commodity.

In the embodiment, matters that the container association unit 122 acquires the identification information of the IoT container 4 from the first terminal 2, then acquires the customer information of the shop-visiting customer from the POS terminal 3, associates the acquired identification information and the customer Information with each other are described. However, the container association unit 122 is not limited thereto, and may acquire the customer information of the shop-visiting customer from the POS terminal 3, then acquire the identification information of the IoT container 4 from the first terminal 2, and associate the acquired identification information and customer information with each other. In such a case, when the customer information of the shop-visiting customer is acquired from the POS terminal 3, the container association unit 122 stores the customer information as the shop-visiting customer ID 131c and “0” as the utilization time 131d in the container management table 131 in association with each other. When the identification information of the IoT container 4 is acquired from the first terminal 2, the container association unit 122 may store the identification information in the IoT container ID 131a corresponding to the shop-visiting customer ID 131c that is currently stored in the container management table 131.

In the embodiment, matters that the image change unit 125 changes the image to be displayed on the IoT container 4 according to the lapse of time from the timing when utilization of the IoT container 4 is started are described. However, the image change unit 125 is not limited thereto, and may change the image to be displayed on the IoT container 4 according to information of a sensor attached to the IoT container 4. As the sensor referred to here, for example, a temperature sensor and a pressure sensor may be included.

For example, it is assumed that the sensor is a temperature sensor. In such a case, the IoT container management server 1 acquires the temperature of the IoT container 4 from the temperature sensor of the IoT container 4 being utilized at predetermined time intervals. In a case where the container management table 131 is referred to and the acquired temperature conforms to a predetermined distribution condition, the image change unit 125 may transmit the distribution image corresponding to the conforming distribution condition to the IoT container 4 corresponding to the acquired temperature. In the distribution rule table 133, it is sufficient that, for example, the expression “The temperature is 100° C.” as the distribution condition 133a and the expression “Please be careful because it is Hot.” as the distribution image 133b may be stored. As another example, it is sufficient that the expression “The temperature is 80° C. to 90° C.” is stored as the distribution condition 133a and “It's time to drink!” is stored as the distribution image 133b.

Effect of Embodiment

As described above, the IoT container 4 includes the display unit 42 for displaying the commodity and the operation unit 43 for transmitting a purchase request for the displayed commodity. The IoT container 4 includes the communication unit 41 that transmits identification information corresponding to the IoT container 4 and the purchase request for the commodity in response to the operation by the operation unit 43. With this, the customer who possesses the IoT container 4 may instruct purchasing of the commodity without visiting the register counter.

The display unit 42 of the IoT container 4 displays the image of the purchased commodity in response to completion of settlement performed in response to transmission of the purchase request. With this, the purchased commodity may be confirmed from the display unit 42.

The POS terminal 3 also includes the storing unit 33 that stores identification information corresponding to the IoT container 4 and the settlement information 333 of the commodity contained in the IoT container 4. The POS terminal 3 includes the settlement processing unit 322 that executes settlement processing relating to purchase of a commodity in response to a purchase request of the commodity using the commodity information 332 stored in the storing unit 33 when the identification information corresponding to the IoT container 4 and the purchase request of the commodity provided by being contained in the IoT container 4 are received. With this, the customer may settle the purchased commodity without going to the POS terminal 3 (for example, a register counter on which the POS terminal 3 is installed).

Others

Respective constituent elements of each device illustrated in the drawings may not be configured physically as illustrated. That is, specific forms of distribution and integration of respective devices are not limited to those illustrated, and some or all of the devices may be configured by being distributed or integrated functionally or physically in predetermined units according to various loads and use situation, and the like.

Some or all of various processing functions performed in the IoT container management server 1, the POS terminal 3, and the IoT container 4 may be executed on a CPU (or a micro-computer such as an MPU, a micro controller unit (MCU) or the like). It goes without saying that some or all of various processing functions are executed on a program analyzed and executed by a CPU (or a micro-computer such as an MPU, an MCU, and the like) or on hardware by a wired logic.

Various processing described in the embodiment described above may be realized by executing a program prepared in advance by a computer. Accordingly, in the following, an example of a computer (hardware) that executes a program having the same function as the embodiment described above will be described. FIG. 16 illustrates an example of a computer that executes a program.

As illustrated in FIG. 16, a computer 200 includes a CPU 203 that executes various arithmetic processing, an input device 215 that receives input of data from the user, and a display control unit 207 that controls a display device 209. The computer 200 includes a reading device 213 that reads a program or the like from a storage medium 211, and a communication control unit 217 that exchanges data with another computer via a network. The computer 200 includes a memory 201 for temporarily storing various types of information, and a storage device 205 such as an HDD. The memory 201, the CPU 203, the storage device 205, the display control unit 207, the reading device 213, the input device 215, and the communication control unit 217 are connected by a bus 219.

The reading device 213 is a device for the storage medium 211, for example, a removable disk, a semiconductor memory, or the like. The storage device 205 stores a program 205a (for example, a purchase notification program, a settlement program) relating to various processing functions.

The CPU 203 reads the program 205a, develops the program 205a in the memory 201, and executes the program 205a as a process. Such a process corresponds to each functional unit of the IoT container management server 1, the POS terminal 3, and the IoT container 4. Program related information 205b is information relating to processing of the program 205a and corresponds to the container management table 131, the shop-visiting customer management table 132, the distribution rule table 133, the image 134, and the like. Then, for example, the storage medium 211 stores each information such as the program 205a. The storage medium 211 corresponds to, for example, a portable recording medium such as a CD-ROM, a DVD disk, a universal serial bus (USB) memory, a semiconductor memory such as a flash memory, or a hard disk drive.

The program 205a may not be stored in the storage device 205 from the beginning. For example, the program 205a is stored in the “portable physical medium” that is the storage medium 211 to be inserted into the computer 200. Then, the computer 200 may read the program 205a from the storage medium 211 and execute the program 205a. The program 205a may be stored in a device connected to a public line, the Internet, a LAN, and the like, and the computer 200 may read the program 205a from the device and execute the program 205a.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A container comprising:
a touch screen configured to display a first area and a second area, the first area including an image regarding a commodity advertisement, the second area including an operation unit configured to receive a manipulation by a user; and
a transmission circuitry configured to transmit a purchase request when the operation unit displayed on the touch screen receives the manipulation, the purchase request including a first identification for the container and a second identification for a commodity displayed on the first area of the touch screen.

2. The container according to claim 1,
wherein the touch screen is configured to display an image indicating that the commodity identified by the second identification included in the purchase request is purchased, when a settlement occurred by the purchase request is completed.

3. The container according to claim 1, further comprising:
a body configured to contain a beverage.

4. A settlement apparatus comprising:
a memory configured to store a first identification for a container and a settlement information that includes a second identification for a commodity contained in the container;
a processor circuitry coupled to the memory, the processor circuitry being configured to execute a settlement process when a purchase request is received, the purchase request including the first identification for the container and the second identification for the commodity, the settlement process including performing a settlement regarding a purchase of the commodity corresponding to the purchase request in accordance with the settlement information stored in the memory.

5. A shop system comprising:
a container including
a touch screen configured to display a first area and a second area, the first area including an image regarding a commodity advertisement, the second area including an operation unit configured to receive a manipulation by a user, and
a transmission circuitry configured to transmit a purchase request when the operation unit displayed on the touch screen receives the manipulation, the purchase request including a first identification for the container and a second identification for a commodity displayed on the first area of the touch screen; and
a settlement apparatus including
a memory configured to store the first identification for the container and a settlement information that includes the second identification for the commodity,
a processor circuitry coupled to the memory, the processor circuitry being configured to execute a settlement process when the purchase request is received from the container, the settlement process including performing a settlement regarding a purchase of the commodity corresponding to the purchase request in accordance with the settlement information stored in the memory.
